(19) United States
(12) Patent Application Publication
(10) Pub. No.: US 2015/0213726 A1
(43) Pub. Date: Jul. 30, 2015

(54) SYSTEM AND METHODS FOR AUTOMATIC COMPOSITION OF TUTORIAL VIDEO STREAMS

(71) Applicant: EXPLOREGATE LTD., MAZKERET BATYA (IL)

(72) Inventors: YEHUDA HOLTZMAN, Mazkeret Batya (IL); ORIT FREDKOF, Rishon LeTzion (IL); MISTY REMINGTON, Rockville, MD (US); JACKIE ASSA, Tel Aviv (IL)

(73) Assignee: EXPLOREGATE LTD., MAZKERET BATYA (IL)

(21) Appl. No.: 14/607,886

(22) Filed: Jan. 28, 2015

(30) Foreign Application Priority Data
Jan. 28, 2014 (IL) 230697

(51) Int. Cl. G09B 5/06

(52) U.S. Cl. CPC G09B 5/06

(57) ABSTRACT

A tutorial-composition system and method for composing an ordered digital tutorial program, adapted to provide an instructive presentation in a pre-selected target subject matter category. The tutorial-composition system includes a main processing unit including an Automatic Training Plan Engine (ATPE) core engine and a managing module, at least two raw-datasources, tutorials database and a computer-readable medium for storing the ordered digital tutorial program. The raw-data-sources may include tutorials databases, other local data sources and remote data sources. The managing module manages the computerized generation of the ordered digital tutorial program. The ATPE core engine is configured to analyze the raw-data-source in two phases: a preprocessing phase, in which a map of possible video stream paths is created, and an automatic processing phase, in which the ordered digital tutorial program is composed.

### CROSS-REFERENCE TO RELATED APPLICATION

The present application claims priority Israel Patent Application No. 230697, filed on Jan. 28, 2014, which is incorporated by reference in its entirety.

### FIELD

The present application generally relates to systems and methods for tutorial video streams and particularly, to a system and methods for automatic creation of an ordered path of tutorial video streams, typically from a large collection of video clips and/or additional media forms.

### BACKGROUND

The large number of high quality commercial multimedia clips, as well as recorded audio streams, digital books and printed, hard copy books and other publications, together with related information such as online tutorial transcripts, FAQ (frequently asked questions) descriptions, and forums discussions, generates a large corpus of answers to virtually any user question. Nevertheless, the unordered nature of this information makes it difficult to access and comprehend by non-expert users looking for a specific concept or term.

There is therefore a need for a system and methods for generating a coherent, complete and concise summary of a selected subject matter, by assembling statements and video sub-clips from a large collection of video clips and additional media, into a single tutorial video stream of the selected subject matter. The assembled tutorial video stream supports the learning process of a target user that wants to learn aspects of the selected subject matter in a methodical sequenced manner.

### SUMMARY

The principle intentions of the present description include providing a system and methods for generating a coherent, complete and concise video presentation of a particular subject matter, by assembling statements and video sub-clips from a large collection of clips and additional media, into a single tutorial of the subject matter in question. Similarly, the principle intentions of the present disclosure include providing a system and methods for generating a coherent, complete and concise audio presentation of a particular subject matter, a digital book of a particular subject matter, which digital book may then be printed in a hard copy, if so desired.

All mentioned above raw-data-sources, video clips, audio streams and publications, all contain textual data. The textual data is either provided in the raw-data-sources or is extracted therefrom. The textual data, in digital form, is then analyzed to yield an ordered tutorial program adapted to cover aspects of learning the particular subject matter.

The method focuses on two main concepts. Given a predefined (typically, by a user) subject matter, the first stage includes determining and extracting sub-clips (or audio streams segments, or publication segment), herein after referred to as “extracted clips”, wherein each extracted clip contains at least one aspect of that predefined subject matter and properties thereof. The second stage includes ordering the extracted clips and constructing an orderly and coherent video lecture presentation (or an audio stream lecture, or a publication), which incorporates the extracted clips. The resulting sequence is designed to support the learning process of the target user, and is suited toward acquiring new knowledge by using the target user level of understanding and prior knowledge.

The method can be applied to both textual and video data that contains verbal audio and/or printed text. Preferably, the video sub-clips include metadata and the output of the video data includes video summarization clips, whereas textual data (such as the forums, FAQ, and related sites data), is summarized in textual form. For the sake of clarity, we use herein video composition terminology although we mean both video and text data summarization.

The terms “tutorial” or “tutorial program”, as used herein, refer to an instructive presentation composed of video streams/clips, designed to lecture or educate about a preconfigured subject matter.

The term “path”, when used in conjunction with selected video streams/clips, is referred to an ordered set of video streams/clips selected from a group of video streams/clips, typically a group that is larger than the length of the path. The path of selected video streams/clips is ordered in a methodical sequenced manner.

The term “textual data”, when used in conjunction with being extracted from video streams/clips, is referred to textual data in digital form that may be extracted from printed text data, audible verbal data or from image data.

According to the teachings of the present disclosure, there is provided a computer-implemented method for composing an ordered digital tutorial program, adapted to provide an instructive presentation in a pre-selected target subject matter category. The ordered digital tutorial program is composed from selected existing textual data sources containing at least one aspect of the target subject matter category. The method includes the steps of providing a tutorial-composition system, performing a preprocessing procedure for generating a map of possible paths through selected raw-data-sources that may be combined to form a tutorial program adapted to provide an instructive presentation in the pre-selected target subject matter category, and automatically processing the map of possible raw data paths for generating the an ordered digital tutorial program.

The tutorial-composition system includes a main processing unit having an Automatic Training Plan Engine (ATPE) core engine, and a tutorial database, wherein the main processing unit is in communication flow with local or remote data sources containing multiple raw-data-sources that incorporate the existing textual data.

The main processing unit is coupled to operate with a computer-readable medium having computer-executable instructions stored thereon that, when executed by the processor, cause the main processing unit to perform operations.

The preprocessing procedure including the steps of:
a) selecting at least two raw-data-sources that contain at least some data of the target subject matter category, from the multiple raw-data-sources;
b) obtaining textual data and metadata from each of the selected raw-data-sources;
c) creating a common dictionary of the category, from the extracted textual data wherein typically, with no limitations, the common dictionary includes key terms selected from the textual data and metadata;
d) selecting pairs of raw-data-sources from the selected raw-data-sources;
e) calculating equivalence and partial order between each of the pairs of raw-data-sources by the ATPE core engine; and
f) determining a map of possible raw data paths using the equivalence and partial order.

The automatic processing including the steps of:
a) providing the training requirements by the user;
b) extracting key terms from the training requirements;
c) determining the start and end locations for the ordered digital tutorial program being formed;
d) computing a best path in the map of possible raw data paths by the ATPE core engine; and
e) composing the resulting sequence of raw-data-sources, as defined by the best path, to thereby form the ordered digital tutorial program, wherein the order is derived from the content inter-dependency between the raw-data-sources.

Optionally, the automatic processing including the steps of:
f) playing the ordered digital tutorial program by a user;
g) collecting feedback from the user; and
h) performing the method starting at the step of selecting pairs of raw-data-sources from the selected raw-data-sources [step (d) of the preprocessing procedure].

The raw-data-sources are selected from the group including video clips, audio streams digital textual sources or printed textual sources transformed into digital form.

The obtaining of textual data and metadata from each of the selected raw-data-sources may include extracting the textual data and metadata from audio data of the selected raw-data-sources.

Optionally, the calculating of equivalence and partial order between each of the pairs of raw-data-sources includes the following steps:
a) assigning weights of importance to each key term in the dictionary;
b) computing a vector of equivalence for each group of raw-data-sources, wherein the vector includes an array of prevalence values computed using the importance weights; and
c) compares the vector of equivalence of each of the pairs of raw-data-sources, to thereby determine the partial order within each of the pairs of raw-data-sources.

Optionally, the tutorial-composition method further includes the steps of:
a) receiving feedback from the user regarding the ordered digital tutorial program;
b) reselecting pairs of raw-data-sources from the selected raw-data-sources; c) calculating equivalence and partial order between each of the reselected pairs of raw-data-sources by the ATPE core engine;
d) determining a map of possible raw data paths using the equivalence and partial order; and
e) automatically processing the map of possible raw data paths for generating the ordered digital tutorial program.

An aspect of the present disclosure is to provide a computer-readable medium embodying a set of instructions, which, when executed by one or more processors cause the one or more processors to perform a method including some or all off the steps of the tutorial-composition method.

An aspect of the present disclosure is to provide a tutorial-composition system for composing an ordered digital tutorial program adapted to provide an instructive presentation in a pre-selected target subject matter category. The tutorial-composition system includes main processing unit including an ATPE core engine and a managing module, at least one raw-data-source, tutorials database (DB), and a computer-readable medium for storing the ordered digital tutorial program.

The at least one raw-data-source is obtained from the group of data sources consisting of the tutorials DB, other local data sources and remote data sources.

If the desired ordered digital tutorial program does not exists in the tutorials DB, the managing module manages the computerized generation of the ordered digital tutorial program. The ATPE core engine is configured to analyze the at least one raw-data-source in two phases: a preprocessing phase and an automatic processing phase. In the preprocessing phase a map of possible video stream paths, within the raw-data-sources, is created, and in the automatic processing phase, the ordered digital tutorial program is composed.

### BRIEF DESCRIPTION OF THE DRAWINGS

The present disclosure will become fully understood from the detailed description given herein below and the accompanying drawings, which are given by way of illustration and example only and thus not limitative of the present disclosure, and wherein:

FIGS. 1A-C are schematic block diagram illustrations of the components of an automatic tutorial-composition system, according to an embodiment of the present disclosure.

FIG. 2 is a detailed schematic block diagram illustration of the components of the tutorial-composition system shown in FIG. 1.

FIG. 3 shows a schematic flowchart diagram of a method for automatic creation of a desired tutorial video stream, according to an embodiment of the present disclosure.

FIG. 4 shows a schematic illustration of an example of the preprocessing phase of building equivalence and order vectors among pairs of video clips selected from a collection of video clips.

FIG. 5 shows a schematic flowchart diagram of a method for automatic creation of a desired tutorial video stream, according to an embodiment of the present disclosure.

FIG. 6 shows a schematic illustration of an example of the automatic processing phase of determining the best path of the yielded tutorial video stream using equivalence and ordering analysis of the equivalence and order vectors formed in the preprocessing phase.

### DETAILED DESCRIPTION

The present disclosure will now be described more fully hereinafter with reference to the accompanying drawings, in which preferred embodiments of the disclosure are shown. This disclosure may, however, be embodied in many different forms and should not be construed as limited to the embodiments set forth herein; rather, these embodiments are provided, so that this disclosure will be thorough and complete, and will fully convey the scope of the disclosure to those skilled in the art.

An embodiment is an example or implementation of the disclosure. The various appearances of “one embodiment,” “an embodiment” or “some embodiments” do not necessarily all refer to the same embodiments. Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the disclosure. It is understood that the phraseology and terminology employed herein is not to be construed as limiting and are for descriptive purpose only.

Methods of the present disclosure may be implemented by performing or completing manually, automatically, or a combination thereof, selected steps or tasks. The order of performing some methods step may vary. The descriptions, examples, methods and materials presented in the claims and the specification are not to be construed as limiting but rather as illustrative only.

Meanings of technical and scientific terms used herein are to be commonly understood as to which the disclosure belongs, unless otherwise defined. The present disclosure can be implemented in the testing or practice with methods and materials equivalent or similar to those described herein.

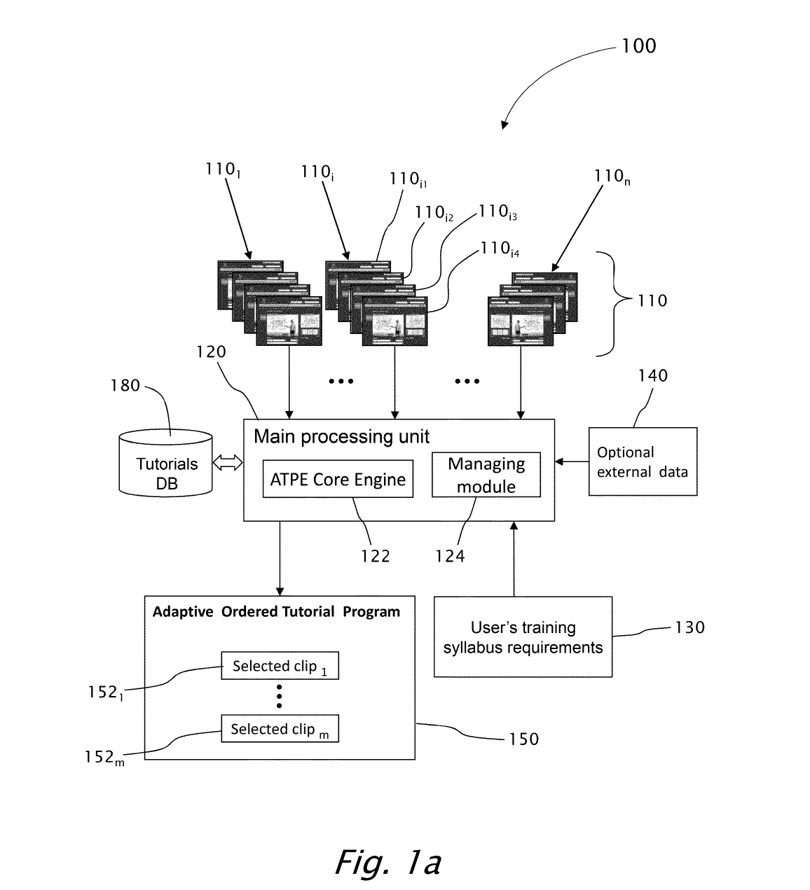

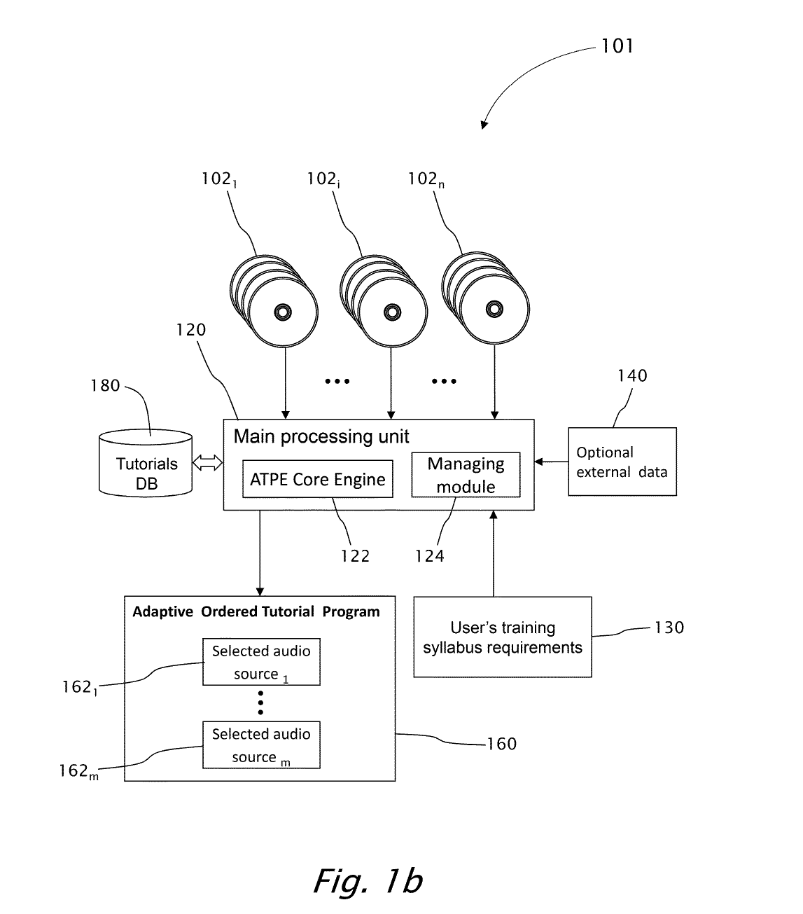

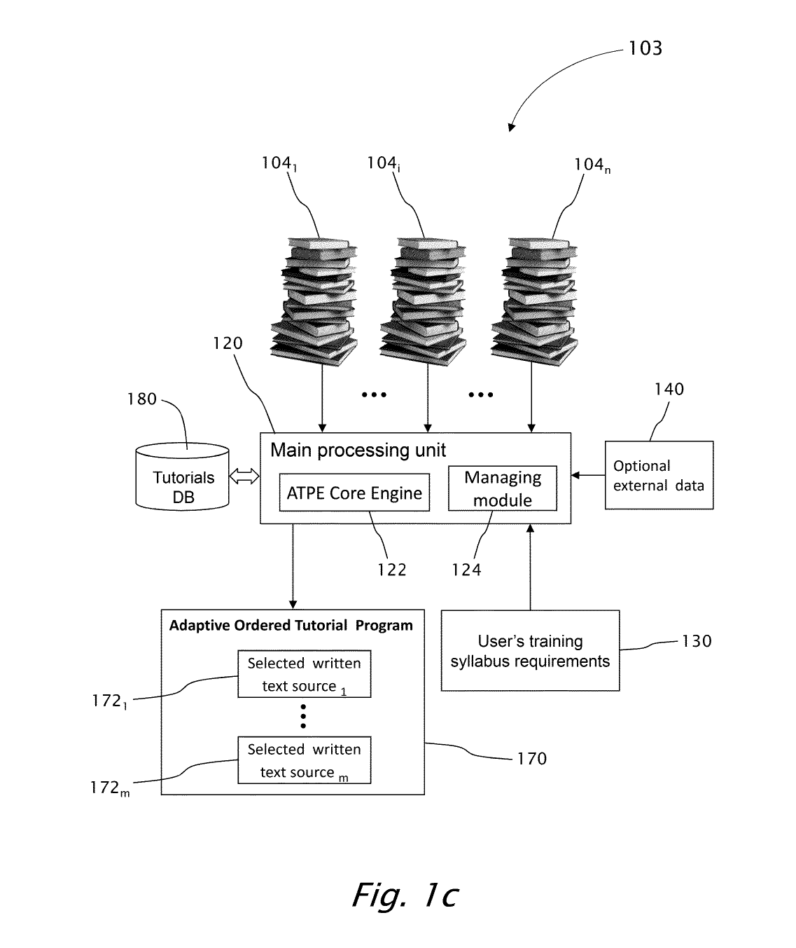

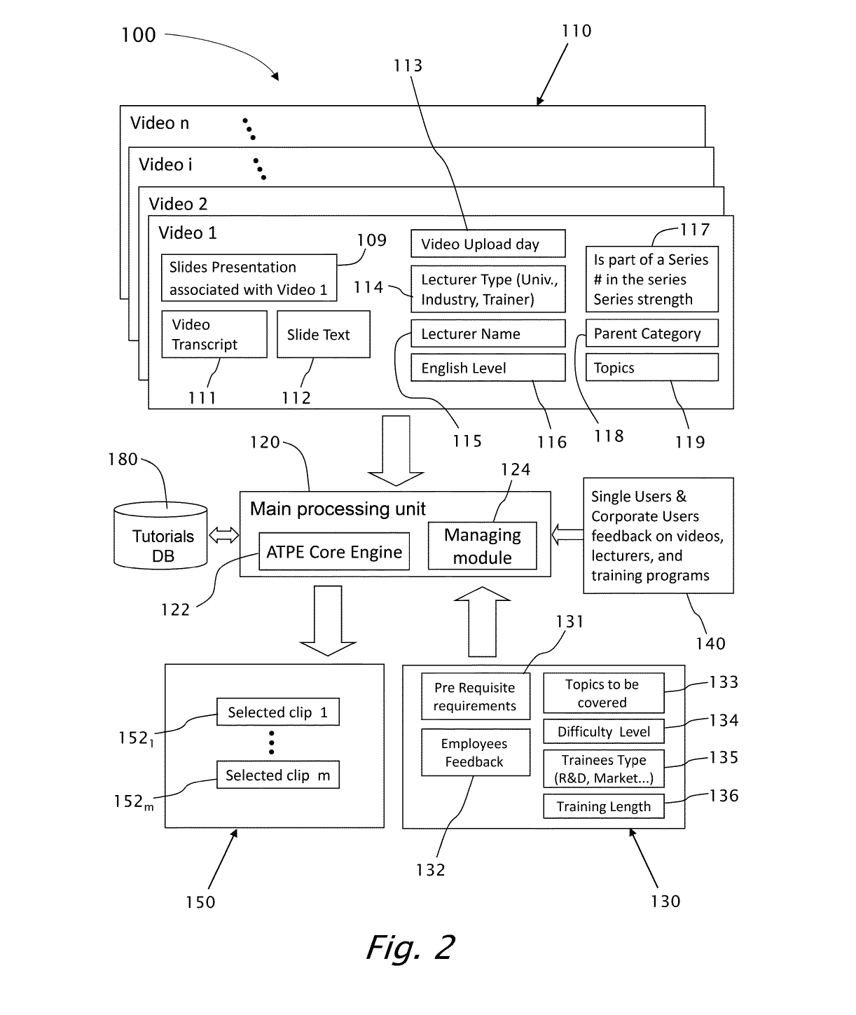

Reference is now made to the drawings. FIG. 1a is a schematic block illustration of a tutorial-composition system 100, according to an embodiment of the present disclosure, for composing a tutorial session from video clips 110. FIG. 1b is a schematic block illustration of a tutorial-composition system 101, according to an embodiment of the present disclosure, for composing a tutorial session from audio sources 102. FIG. 1c is a schematic block illustration of a tutorial-composition system 103, according to an embodiment of the present disclosure, for composing a tutorial session from written textual sources 104. Reference is also made to FIG. 2, illustrating a detailed schematic block diagram of the components of the tutorial-composition system 100.

Tutorial-composition system 100 includes a main processing unit 120 having an Automatic Training Plan Engine (ATPE) core engine 122 and a managing module 124. Tutorial-composition system 100 further includes a tutorial database (DB) 180 for storing containing data of one or more subject matter categories.

When a user wishes to obtain a tutorial video stream for teaching a particular subject matter category, he/she provides that category to the system, including the training syllabus requirements 130. If that category does not exist in tutorial DB 180, then a preprocessing phase of collecting and creating a map of possible video stream paths, managed by managing module 124, is performed. A collection of raw-data-sources containing textual data segments, related to the requested category are collected and provided as input to main processing unit 120. The collection of raw-data-sources may include video clips 110, or audio sources 102 or written textual sources 104.

It should be noted the present disclosure is described mostly in terms of the target tutorial video stream being composed out of video clips, but the present disclosure is not limited to composing a tutorial session from video clips. The tutorial-composition system may use, within the scope of the present disclosure, any audio input 102 (see FIG. 1b) and/or written textual sources 104 (see FIG. 1c).

If that category does exist in tutorial DB 180, then a second phase, an automatic processing phase of composing the requested subject matter category is performed. The automatic processing phase of composing the requested subject matter category yields an ordered target tutorial program 150 can then be played by the user.

Each raw-data-source 110ᵢ may include multiple input video clips 110ᵢⱼ. In the example shown in FIG. 1a, raw-data-source 110ᵢ includes 4 (four) video clips: video clip 110ᵢ₁, video clip 110ᵢ₂, video clip 110ᵢ₃, and video clip 110ᵢ₄.

Each video clip 110ᵢⱼ may include a presentation that the presenter of the tutorial program captured in that video clip 110ᵢⱼ, and that presenter may provide, along with video clip 110ᵢⱼ, the slide presentation 109 associated with a particular video clip of raw-data-source 110ᵢ. Optionally, the presenter may further provide, along with video clip 110ᵢⱼ, the transcript 111 of video clip 110ᵢⱼ. However, if not provided, main processing unit 120 extract the textual data 111 of video clip 110ᵢⱼ from raw-data-source 110ᵢ and/or the textual data 112 from slide presentation 109.

Optionally, raw-data-source 110ᵢ is further provided with metadata such as video upload day 113, lecturer type (university, industry, trainer, etc.) 114, lecturer name 115, language and language level 116, parent category 118, topics 119 and if video clip 110ᵢⱼ is part of a series of video clips 110ᵢ (117)—the length of the series and/or the sequence number of video clip 110ᵢⱼ in that raw-data-source 110ᵢ.

Main processing unit 120 may be further provided with various external data 140, such as user's feedback on particular video streams, on particular lecturers, and on particular training programs. It should be noted that the terms “video clip” and “video stream” are used herein interchangeably.

Training syllabus requirements 130 may include various pre requisite requirements 131, employees feedback 132 related to the requested category, topics to be covered 133, difficulty level 134, target users type (R&D, marketing, etc.) 135 and training length 136.

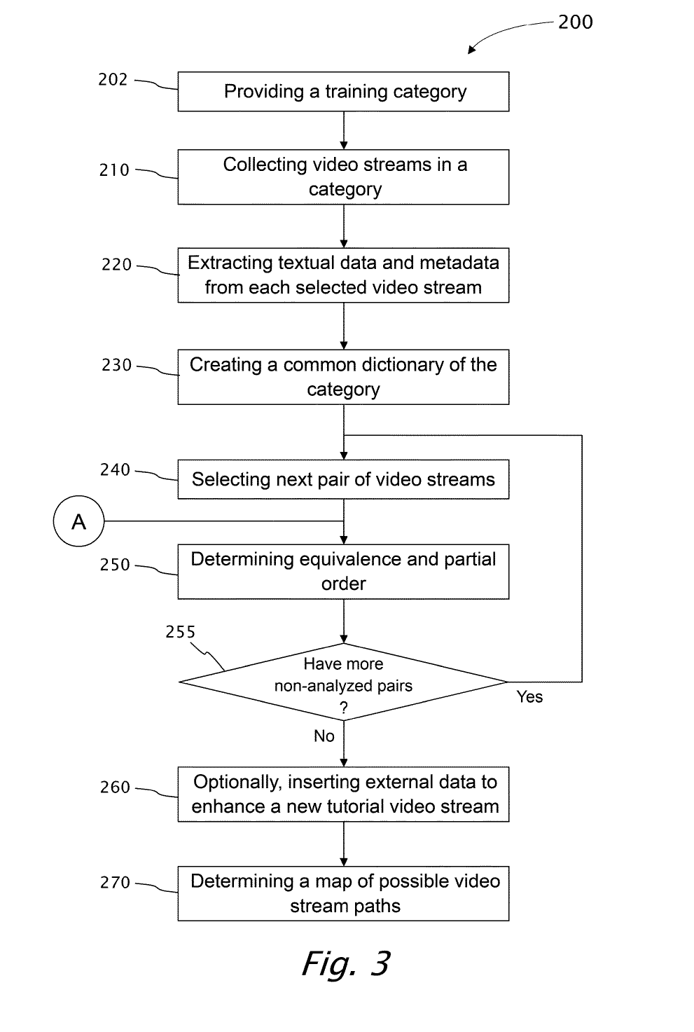

Reference is now made to FIG. 3, a schematic illustration of an example flowchart of the preprocessing phase 200 of equivalence and order vectors among pairs of video clips 310 selected from a collection of video clips of raw-data-source 110. The collection of video clips of raw-data-source 110 is assembled after providing, in step 202, a desired category for teaching a particular subject matter.

After exhausting the all the pairs of the video clips of raw-data-source 110, the process yield a map of possible video stream paths that may combine to form a video tutorial program in the requested category. The preprocessing phase 200 proceeds with the following steps:

### Step 210: Collecting Video Streams in a Category.

An operator of a tutorial-composition system 100 collects selected video streams raw-data-sources 110ᵢ related to in a requested learning topic category, provided by a user. Video streams raw-data-sources 110ᵢ are obtained from any available source such as the Internet, tutorial DB 180, a corporate database or any other source.
Similarly, if tutorial-composition system 101 is used, audio streams 102, are obtained from any available source such as the Internet, tutorial DB 180, a corporate database, libraries or any other source.
   Step 220: Extracting Textual Data and Metadata from Each Selected Video Stream.
Main processing unit 120 extracts the textual data 111 of video clip 110ᵢⱼ from the audio of video clip 110ᵢⱼ and/or the text appearing in the images, using conventional technics.
Furthermore, each input video clip 110ᵢⱼ may include a slide presentation 109 that the presenter of the tutorial program captured in that video clip 110ᵢⱼ. The slide presentation 109 associated with video clip 110ᵢⱼ may have been provided by the presenter, along with video clip 110ᵢⱼ. Main processing unit 120 then extracts the textual data 112 from slide presentation 102.
Furthermore, the transcript 111 of video clip 110ᵢⱼ may have been further provided the presenter, along with video clip 110ᵢⱼ.
Optionally, video clip 110ᵢⱼ is further provided with metadata such as video upload day 113, lecturer type (university, industry, trainer, etc.) 114, lecturer name 115, language and language level 116, parent category 118, topics 119 and if video clip 110ᵢⱼ is part of a series of video clips 110ᵢ (117)—the length of the series and/or the sequence number of video clip 110ᵢⱼ in that raw-data-source 110ᵢ.
It should be noted that if tutorial-composition system 101 is used, audio streams 102, main processing unit 120 extracts the textual data from audio sources 102ᵢ, using conventional technics.
This steps yields textual data and textual metadata in digital form and is referred to as extracted textual data.

### Step 230: Creating a Common Dictionary of the Category.

Main processing unit 120 creates a common dictionary of the learned topic category, using key terms selected from the extracted textual data and metadata.
It should be noted that if tutorial-composition system 103 is used, the textual data is converted to digital form written text source 104ᵢⱼ, using conventional methods such as OCR.
Typically, text semantics methods are used to determine statements which discuss the key terms. Typically, machine learning techniques (such as raking algorithms) are applied to determine best paragraphs for defining a key term, and for realizing the key terms interrelations. This stage also determines similarity between the definitions, removing redundant definitions.

### Step 240: Selecting Next Pair of Video Streams.

Video streams 110ᵢⱼ are grouped in groups of raw-data-sources 110ᵢ, have a common characteristic such as a common lecturer, lecturing in the requested learning topic category.
Main processing unit 120 then selects the next pair of video streams 110, among selected raw-data-sources 110, wherein the selected pair are to be analyzed for tutorial coverage equivalence.

### Step 250: Determining Equivalence and Partial Order.

Main processing unit 120 analyzes the current pair of video clips 110 to determine equivalency between the two video clips 110, and if determined that the two video clips 110 are not equivalent, determining at least a partial logical order of video clips 110 within the pair of the selected raw-data-sources 110 respectively containing video clips 110 containing the current pair of video clips 110.
   Step 255: Checking if there are More Non-Analyzed Pairs of Video Clips.
Main processing unit 120 checks if there are more pairs of video clips 110 that have not been yet analyzed for tutorial coverage equivalence.
If there are more pairs of video clips 110 that have not been yet analyzed, go to step 240.

### Step 260: Optionally, Inserting External Data to Enhance a New Tutorial Video Stream.

Optionally, external data in inserted to enhance the formation of a new tutorial video stream that will comply with the requested learning topic category, provided by a user.

### Step 270: Determining a Map of Possible Video Stream Paths.

Main processing unit 120 determines a map of possible video stream paths for the formation of a new tutorial video stream that will comply with the requested learning topic category. This calculation is based on the equivalence and partial order analysis.
   (end of product-recognition method 200)

### Preprocessing Phase Example

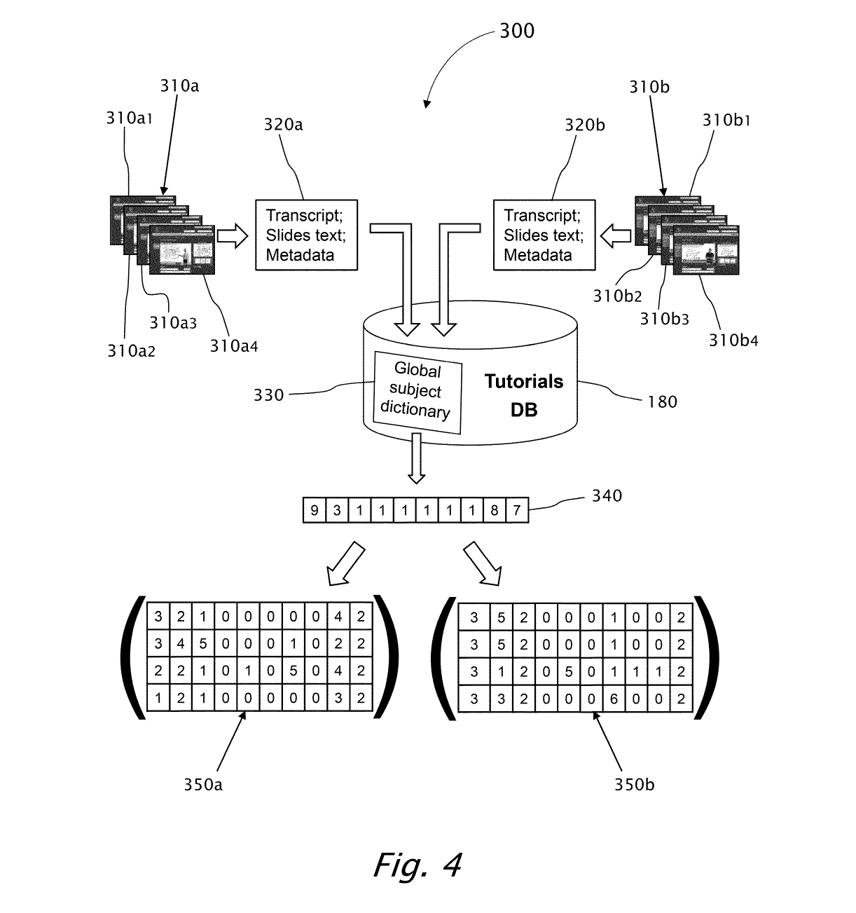

FIG. 4 shows a schematic illustration of an example sub-system 300, demonstrating, with no limitations, the preprocessing phase of building equivalence and order vectors among pairs of video clips selected from a collection of video clips 110. In example sub-system 300, two raw-data-source groups 310 of video clips are processed: first raw-data-source group 310a and second raw-data-source group 310b, wherein each raw-data-source group contains 4 (four) video clips. Main processing unit 120 extracts the textual data (transcript) from the audio of each video clip 310. Furthermore, Main processing unit 120 extracts the textual data from slide presentation accompanying each video clip in each raw-data-source group 310, as well as the accompanying metadata.

Main processing unit 120 then creates a common dictionary 330 of the category at hand, using key terms selected from the extracted textual data and metadata. Typically, dictionary 330 is stored in tutorial DB 180.

Weights of importance 340 are then assigned to each key term of dictionary 330. In this example, there are 10 (ten) key terms, each coupled with an individual weight. Main processing unit 120 then computes a vector of equivalence 350 for each raw-data-source group 310 of video clips, wherein the vector has an array of prevalence values for each video clip in each raw-data-source group 310. The prevalence value of each video clip in each raw-data-source group 310 is computed using importance weights 340.

Main processing unit 120 then compares the vector of equivalence 350a of first raw-data-source group 310a and the vector of equivalence 350b of second raw-data-source group 310b, to thereby compute a distance D₁₁ (video clip 310a1, video clip 310a1), D₁₂ (video clip 310a1, video clip 310a2), . . . , distance D₂₂ (video clip 310a2, video clip 310a2), D₂₃ (video clip 310a2, video clip 310a3), . . . , etc.

Main processing unit 120 further determines a partial order of the video clips of first raw-data-source group 310a and second raw-data-source group 310b: partial order O₁₁ (video clip 310a1, video clip 310a1), O₁₂ (video clip 310a1, video clip 310a2), . . . , partial order O₂₂ (video clip 310a2, video clip 310a2), O₂₃ (video clip 310a2, video clip 310a3), . . . , etc.

The resulting distances Dᵢⱼ and partial orders Oᵢⱼ are referred to herein as the map of possible video stream paths for the two raw-data-source groups 310 of video clips, first raw-data-source group 310a and second raw-data-source group 310b, the map being the outcome of the preprocessing phase of the process of composing a new tutorial video stream that will comply with the requested learning topic category.

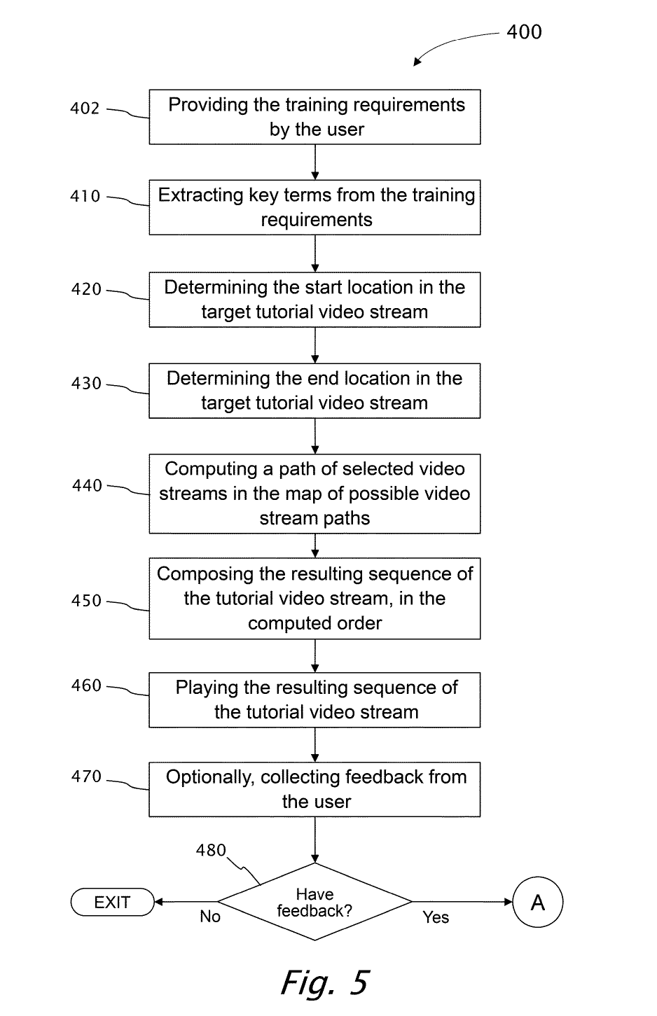

Reference is now made to FIG. 5, a schematic illustration of an example flowchart of the automatic processing phase 400 of calculating a best path within the collection of video clips 110 that complies with the training requirements for teaching the particular subject matter, as provided by the end user in step 402. The automatic processing phase 400 proceeds with the following steps:

Step 410: Extracting Key Terms from the Training Requirements.
Main processing unit 120 extracts key terms from the training requirements for teaching the particular subject matter, as provided by the end user in step 402.
The extracted key term(s) is used to either fetch an existing map of possible video stream paths, or initiates a preprocessing process 200 to generate a map of possible video stream paths.

### Step 420: Determining the Start Location in the Target Tutorial Video Stream.

Main processing unit 120 determines the start location in the target tutorial video stream 152₁ (see FIG. 2), based on the training requirements for teaching the particular subject matter, as provided by the end user in step 410. The start location is the first video clip 110 of target tutorial video stream 152₁.

### Step 430: Determining the End Location in the Target Tutorial Video Stream.

Main processing unit 120 determines the start location in the target tutorial video stream 152ₘ, based on the training requirements for teaching the particular subject matter, as provided by the end user in step 410. The end location is the last video clip 110 of target tutorial video stream 152ₘ.

### Step 440: Computing a Best Path of Selected Video Streams in the Map of Possible Video Stream Paths.

ATPE core engine 122 of main processing unit 120 analyzes the map of possible video stream paths of selected video streams, as generated in the preprocessing phase process 200, in view of the training requirements for teaching the particular subject matter provided in step 410. Among other parameters, the analysis is based on the equivalence and partial order vectors, on permissible passes/non-permissible data obtained from external source (such as the lecturer and/or the end user), and on other parameters obtained from the training requirements for teaching the particular subject matter provided in step 410, and from various external data 140. Among other sources, the sources of external data 140 include user's feedback on particular video streams, particular lecturers, and data from other tutorial programs. The resulting best path is an ordered set of video streams/clips that best complies with the training category as defined for the target user.

### Step 450: Composing the Resulting Sequence of the Tutorial Video Stream, in the Computed Order.

Main processing unit 120 then composes the sequence of the target tutorial video stream 150, in the computed order, starting with video stream 152₁ and ending with video stream 152ₘ.
Target tutorial video stream 150 is also referred to as ordered digital tutorial program 150, and being in digital form, ordered digital tutorial program 150 may be converted to any other form. For example, if the ordered digital tutorial program is in the form of a digital book 170 (see FIG. 1c), digital book 170 may be printed as a hard copy book.

### Step 460: Playing the Resulting Sequence of the Tutorial Video Stream.

The resulting target tutorial video stream 150 may then be played by the user for him/her to verify the end result and provide feedback.
   Step 470: collecting feedback from the user.
Optionally, main processing unit 120 collects the feedback from the user.
   Step 480: Checking if there is any Feedback from the User.
Main processing unit 120 checks if there is any feedback from the user. If there is any feedback from the user, go to step 250.
   (end of product-recognition method 400)

### Automatic Processing Phase Example

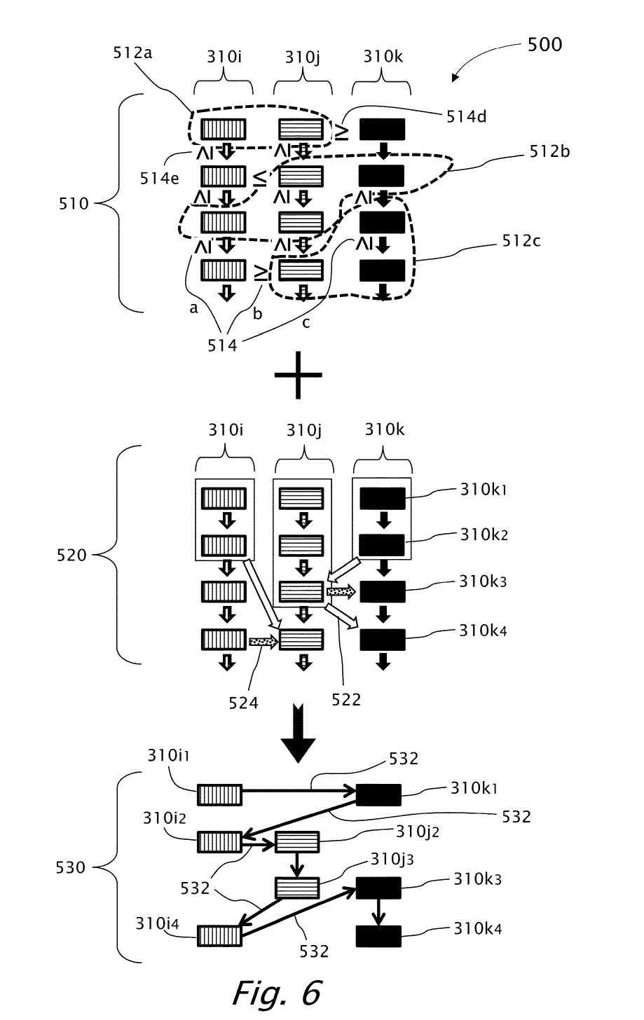

FIG. 6 shows a schematic illustration of an example process 500, demonstrating, with no limitations, the automatic processing phase of determining the best path of the yielded tutorial video stream 150 using equivalence and ordering analysis of the equivalence and order vectors formed in the preprocessing phase.

In example process 500, 3 (three) raw-data-source groups 310 of video clips are processed: a first raw-data-source group 310i, a second raw-data-source group 310j and third raw-data-source group 310k, wherein each raw-data-source group contains 4 (four) video clips. In a first stage 510, main processing unit 120 extracts the textual data (transcript) from the audio of each video clip 310. Furthermore, Main processing unit 120 determines the equivalence groups 512 (from which equivalence groups 512 only one video clip 310 may be selected) and analyzes the partial orders 514 between adjacent video clips 310, as well as the accompanying metadata.

In a second stage 520, main processing unit 120 analyzes the permissible passes (522)/non-permissible passes (524) data obtained from external source (for example, the lecturer and/or the end user).

In a third stage 530, main processing unit 120 determines the best path (in the map of possible video stream paths, as generated in the preprocessing phase process 200), to yield target tutorial video stream 150. In the example shown in FIG. 6, process 500 computes a best path that begins in video clip 310ᵢ₁, proceeds (532) with video clip 310ₖ₁, proceeds with video clip 310ᵢ₂, proceeds with video clip 310ⱼ₂, proceeds with video clip 310ⱼ₃, proceeds with video clip 310ᵢ₄, proceeds with video clip 310ₖ₃ and ends with video clip 310ₖ₄.

Starting video clip 310ᵢ₁ is selected from equivalence group 512a; video clip 310ₖ₁ is selected as to follow equivalence group 512a, as determined by partial order 514d; partial order 514e determines the to follow is video clip 310ᵢ₂; the next to follow is equivalence group 512b, as determined by either partial orders 514 that are set after clip 310ᵢ₂; video clip 310ⱼ₂ is selected from equivalence group 512b; since video clip 310ᵢ₃ must precede video clip 310ᵢ₂, video clip 310ᵢ₃ is the next selection; the next to follow is equivalence group 512c; since it is not allowed to pass from video clip 310ⱼ₃ to video clip 310ₖ₃, and since video clip 310ᵢ₄ must precede equivalence group 512c, video clip 310ᵢ₄ is the next selection; since it is not allowed to pass from video clip 310ᵢ₄ to video clip 310ⱼ₄ (524), and since video clip 310ₖ₃ must precede video clip 310ₖ₄, video clip 310ₖ₃ is the next selection; finally, video clip 310ₖ₄ concludes target tutorial video stream 150.

Although the present disclosure has been described with reference to the preferred embodiment and examples thereof, it will be understood that the disclosure is not limited to the details thereof. Various substitutions and modifications have suggested in the foregoing description, and other will occur to those of ordinary skill in the art. Therefore, all such substitutions and modifications are intended to be embraced within the scope of the disclosure as defined in the following claims.

What is claimed is:

1. A computer-implemented method for composing an ordered digital tutorial program adapted to provide an instructive presentation in a target subject matter category, from selected existing textual data sources containing at least one aspect of the target subject matter category, the method comprising the steps of:
a) providing a tutorial-composition system including:
i. a main processing unit having an Automatic Training Plan Engine (ATPE) core engine; and
ii. a tutorial database,
wherein said main processing unit is coupled to operate with a computer-readable medium having computer-executable instructions stored thereon that, when executed by the processor, cause said main processing unit to perform operations; and
wherein said main processing unit is in communication flow with local or remote data sources containing multiple raw-data-sources that incorporate said existing textual data;
b) performing a preprocessing procedure for generating a map of possible paths through selected raw-data-sources that may combine to form a tutorial program adapted to provide an instructive presentation in the pre-selected target subject matter category, said preprocessing procedure comprising the steps of:
i. selecting at least two raw-data-sources that contain at least some data of the target subject matter category, from the multiple raw-data-sources;
ii. obtaining textual data and metadata from each of said selected raw-data-sources;
iii. creating a common dictionary of the category, from said obtained textual data;
iv. selecting pairs of raw-data-sources from said selected raw-data-sources;
v. calculating equivalence and partial order between each of said pairs of raw-data-sources by said ATPE core engine; and
vi. determining a map of possible raw data paths using said equivalence and partial order; and
c) automatically processing said map of possible raw data paths for generating said ordered digital tutorial program, said automatic processing comprising the steps of:
i. providing the training requirements by the user;
ii. extracting key terms from said training requirements;
iii. determining the start and end locations for said ordered digital tutorial program being formed;
iv. computing a best path in said map of possible raw data paths by said ATPE core engine; and
v. composing the resulting sequence of raw-data-sources, as defined by said best path, to thereby form said ordered digital tutorial program, wherein the said order is derived from the content inter-dependency between said raw-data-sources.

2. A computer-implemented method as in claim 1, wherein said automatic processing step further comprises the steps of:
vi. playing said ordered digital tutorial program by a user;
vii. collecting feedback from said user; and
viii. performing said method starting at step (b) sub-section (iv).

3. A computer-implemented method as in claim 1, wherein said raw-data-sources are video clips.

4. A computer-implemented method as in claim 1, wherein said raw-data-sources are audio streams.

5. A computer-implemented method as in claim 1, wherein said raw-data-sources are digital textual sources or printed textual sources transformed into digital form.

6. A computer-implemented method as in claim 3, wherein said obtaining of textual data and metadata from each of said selected raw-data-sources includes extracting said textual data and metadata from audio data of said selected raw-data-sources.

7. A computer-implemented method as in claim 4, wherein said obtaining of textual data and metadata from each of said selected raw-data-sources includes extracting said textual data and metadata from audio data of said selected raw-data-sources.

8. A computer-implemented method as in claim 1, wherein said common dictionary comprises key terms selected from said textual data and metadata.

9. A computer-implemented method as in claim 1, wherein said calculating of equivalence and partial order between each of said pairs of raw-data-sources comprises the steps of:
a) assigning weights of importance to each key term in said dictionary;
b) computing a vector of equivalence for each group of raw-data-sources, wherein the vector includes an array of prevalence values computed using said importance weights; and
c) comparing the vector of equivalence of each of said pairs of raw-data-sources, to thereby determine the partial order within each of said pairs of raw-data-sources.

10. A computer-implemented method as in claim 1 further comprises the steps of:
d) receiving feedback from the user regarding said ordered digital tutorial program;
e) reselecting pairs of raw-data-sources from said selected raw-data-sources;
f) calculating equivalence and partial order between each of said reselected pairs of raw-data-sources by said ATPE core engine;
g) determining a map of possible raw data paths using said equivalence and partial order; and
h) automatically processing said map of possible raw data paths for generating said ordered digital tutorial program.

11. A tutorial-composition system for composing an ordered digital tutorial program adapted to provide an instructive presentation in a pre-selected target subject matter category, the tutorial-composition system comprising:
a) a main processing unit comprising an Automatic Training Plan Engine (ATPE) core engine and a managing module;
b) at least one raw-data-source;
c) a tutorials database (DB); and
d) a computer-readable medium for storing said ordered digital tutorial program,
wherein said main processing unit is coupled to operate with a computer-readable medium having computer-executable instructions stored thereon that, when executed by the processor, cause said main processing unit to perform operations;
wherein said at least one raw-data-source is obtained from the group of data sources consisting of said tutorials DB, other local data sources and remote data sources;
wherein if said ordered digital tutorial program does not exists in said tutorials DB, said managing module manages the computerized generation of said ordered digital tutorial program; and
wherein said ATPE core engine is configured to analyze said at least one raw-data-source in two phases:
a) a preprocessing phase of creating a map of possible video stream paths within said raw-data-sources; and
b) an automatic processing phase of composing said ordered digital tutorial program.

12. A tutorial-composition system as in claim 11, wherein said raw-data-sources are video clips.

13. A tutorial-composition system as in claim 11, wherein said raw-data-sources are audio streams.

14. A tutorial-composition system as in claim 11, wherein said raw-data-sources are digital textual sources or printed textual sources transformed into digital form.
